(19) United States
(12) Patent Application Publication
(10) Pub. No.: US 2017/0145190 A1
(43) Pub. Date: May 25, 2017

(54) THERMOCONDUCTIVE COMPOSITION

(71) Applicant: DSM IP ASSETS B.V., Heerlen (NL)

(72) Inventors: Hans Klaas VAN DIJK, Echt (NL); Xubo XU, Echt (NL)

(21) Appl. No.: 15/300,012

(22) PCT Filed: Mar. 23, 2015
(86) PCT No.: PCT/EP2015/056095

§ 371 Date: Sep. 28, 2016

(30) Foreign Application Priority Data
Apr. 1, 2014 (CN) 201410128245.2
Apr. 14, 2014 (EP) 14164590.3

(51) Int. Cl. C08K 7/14; C08L 77/06; C08K 5/03; C08K 3/34

(52) U.S. Cl. CPC C08K 7/14; C08K 3/34; C08L 77/06; C08K 5/03; C08K 2201/001

(57) ABSTRACT

The present invention relates to a thermoconductive polymer composition comprising: a) 10-30 wt. % of glass fibers; b) 40-45 wt. % of talc; c) 20-50 wt. % of a thermoplastic polymer comprising at least one polyamide selected from the group consisting of PA46, PA6, PA66 and mixtures thereof; wherein the sum of a) and b) is at least 50 wt. % and at most 70 wt. % and wherein the weight percentages (wt. %) are relative to the total weight of the composition.

The present invention relates to a thermoconductive polymer composition and a method for the manufacture thereof. Further, the present invention relates to the use of glass fibers as thermoconductivity enhancing agent.

Heat built-up in electronic components, lighting, transformer housings and other devices that produce unwanted heat can severely limit service life and reduce operating efficiency. Metal, an excellent thermal conductor, has traditionally been used for thermal management equipment such as heat sinks and heat exchangers. However, the metal parts suffer from heavy weight and high production costs. Thus, they are being replaced by injection mouldable and extrudable heat-conducting polymer compositions that provide lightweight cooling solutions. Advantages include design flexibility, parts consolidation, corrosion and chemical resistance, reduction of secondary finishing operations and the processing benefits of polymers.

Thermally conductive polymer compositions are typically formed by loading a variety of thermally conductive fillers including metals, ceramics or carbon into a base polymer matrix, wherein the fillers impart thermal conductivity properties to the overall composition. Specifically, examples of common thermally conductive filler materials include aluminium, alumina, copper, magnesium, brass, carbon such as carbon black and graphite, silicon nitride, aluminium nitride, boron nitride, zinc oxide, mica, titanium oxide, and boron carbide. However, in order to produce a composition that has relatively high thermal conductivity values, a high amount of filler material must be loaded into the base polymer matrix. Such highly loaded polymer compositions generally suffer from inferior mechanical properties, e.g. increased brittleness and/or poor mouldability i.e. reduced flow properties, excluding these materials from certain applications. For thermally conductive and electrically insulating compositions, expensive fillers such as boron nitride are used. Moreover, for applications for which a thermally conductive and electrically insulating polymer composition is desirable, the above drawbacks are present in a more outspoken manner, since the feasibility of such a composition is difficult to achieve.

It is a goal of the present invention, amongst other goals, to provide a thermoconductive composition which has good mechanical properties. Specifically, it is a goal of the present invention to provide a thermoconductive thermoplastic composition and a good thermoconductivity and is further electrically insulating. These goals are achieved by the composition according to the present invention comprising, or even consists of:
a) 10-30 wt. % of glass fibers;
b) 40-55 wt. % of talc;
c) 20-50 wt. % of a thermoplastic polymer comprising at least one polyamide selected from the group consisting of PA46, PA6, PA66 and mixtures thereof; and optionally an further component (additive) in an amount 0-5 wt. %, or 10-20 wt. % of a flame retardant,
wherein the sum of a) and b) is at least 50 wt. % and at most 70 wt. % and wherein the weight percentages (wt. %) are relative to the total weight of the composition. The thermoconductive polymer composition of the present invention has a density which is higher than the density of the polyamide composition containing talc (without glass fibers). The density of the polymer composition according to the present invention is above 1.5 g/cm³, preferably above 1.6 g/cm³. The density range of the composition according to the present invention is preferably in the range from 1.6 to 2.1 g/cm³. Density is measured according to standard ISO 1183.

In the context of the present invention, the ranges provided are to be understood as from (and including) the lower value to (and including) the upper value.

According to the present invention, good results have been achieved when the weight ratio of glass fibers:talc is in the range from 1:1 to 1:6. Accordingly, good results can be obtained when the weight ratio glass fiber/talc is in the range from 1:1 to 1:4, particularly good results can be obtained when the weight ratio glass fiber/talc is in the range from 1:2 to 1:4.

The combination of the glass fibers and the talc in amounts and weight ratio as recited above provides a polymer composition having good mechanical properties (strength, elastic modulus, elongation at break), while having an increased thermoconductivity (compared to thermoplastic polymer-containing compositions containing only glass fibers or thermoplastic polymer-containing compositions containing only talc in the same overall amount) and being electrically insulating. The presence of both the glass fibers and talc as recited above provides a synergic effect: the thermoconductivity of the thermoplastic composition is increased when glass fibers are present in a composition comprising a thermoplastic polymer composition and talc, compared to thermoplastic polymer compositions consisting only of the thermoplastic polymer and talc in the same overall amount(no glass fiber), or only of the thermoplastic polymer and glass fibers in the same overall amount (no talc). In particular, this effect is advantageous in compositions wherein component c) is a polyamide.

According to another aspect of the present invention, the glass fibers are used as a thermoconductivity enhancer, or thermoconductivity enhancing agent in thermoconductive polymer composition, in particular in thermoconductive thermoplastic polymer composition. This enhancing effect already is present when the glass fibers are present in an amount of at least 10 wt. % of the total weight of the thermoconductive polymer composition. In thermoplastic polymer compositions comprising a thermoconductive filler, providing glass fibers in an amount of preferably at least 15 wt. % relative to the total weight of the thermoconductive polymer composition is advantageous. The thermoconductive filler is preferably chosen from the group consisting of talc, boron nitride, graphite and a mixture thereof.

In the context of the present invention, component a) is glass fibers. A glass fibre is herein understood to be a material consisting of particles with an aspect ratio of at least 10:1. More preferably the glass fibers consisting of particles with an aspect ratio of at least 15:1, more preferably at least 25:1. The advantage of glass fibres in the thermally conductive polymer composition is that it enhances the thermoconductivity of the talc-containing polyamide composition thereby providing a thermoconductive polymer composition comprising a polyamide and talc which has improved heat conductivity, increased mechanical strength and retains a good electrical isolation. Such an effect is only achieved with the presence of glass fibers and not with a ‘common glass’ component (by common glass is to be understood any form of glass which does not have a fiber form). According to one embodiment of the present invention, good results are obtained when the amount of glass fibers in the composition is in the range from 15 wt. % to 30 wt. %, preferably 15-20 wt. % of the total weight of the composition according to the present invention. In the context of the present invention, it has been observed that the glass fibers in presence of talc in thermoplastic polymers increases the thermoconductivity. An amount of glass fibers in the range from 10 to 30 wt. %, or even 15-20wt. % relative to the total weight of the polymer composition will present the most advantageous and visible synergic effect with talc and will increase the thermoconductivity of the polymer composition. The thermoconductivity increases with the amount of glass fibers present for a same amount of talc. A possible reasoning of this effect is that the glass fiber may form a glass bundle and create a network for thermal transportation. This mechanism may also be applicable for other fillers such as boron nitride or graphite.

In the context of the present invention, ranges are to be understood as including the lower and upper limit values (from is to be understood “as starting from” and to is to be understood as “up to and including”).

In the context of the present invention, component b) is talc. The density of the talc is in the range density is between 1.5 and 4, preferably between 2 and 3. Very good results can be achieved with a talc which density is measured at 2.75 g/cm³. Density is measured according to standard ISO 1183. The term talc is to be understood as a mineral comprising hydrated magnesium silicate, such as having the chemical formula H₂Mg₃(SiO₃)₄ or Mg₃Si₄O₁₀(OH)₂. Advantageously, the talc has the form of plate-like particles of magnesium silicate having a layer structure having a composition of 58-66 wt. % of SiO₂, 28-35 wt. % of MgO, about 5 wt. % of water and various amounts of diverse components such as iron oxides, aluminum oxides, calcium oxide, sodium oxide, potassium oxide, titanium oxide, phosphorus oxides and sulfoxides. The pH of the talc is in the range 8 to 11 depending on its composition. Advantageously, the talc recited as component b) has a number average particle diameter (determined by scanning electron microscopy) in the range from 100 nm to 10 μm, more advantageously from 2 μm to 5 μm. According to one embodiment of the present invention, good results are already obtained when the amount of talc in the thermoconductive polymer composition in the range from 40 wt. % to 45 wt. %, in particular if a flame-retardant is further present in the composition.

According to one embodiment of the present invention, particularly good results are obtained when the sum of components a) and b) is in the range from 55 to 70, advantageously from 60 wt. % to 70 wt. % of the total weight of the composition. Preferably, the sum of components a) and b) is at least 55 wt. %, more preferably at least 60 wt. %, most preferably at least 65 wt. %. Preferably, the sum of components a) and b) is at most 70 wt. %, more preferably at most 67 wt. %.

Preferably, the thermoplastic polymer composition in component c) can further comprise other polyamides, polyesters, polyphenylene sulphides, polyphenylene oxides, polysulfones, polyarylates, polyimides, polyetheretherketones, and polyetherimides, and mixtures thereof. The thermoplastic polymer composition can be an homopolymer or a copolymer of the hereabove selected polymer list. Advantageously, the thermoplastic polymer in component c) is chosen from the group consisting of polyamides, polyesters, polyphenylene sulphides, polyphenylene oxides, polysulfones, polyarylates, polyimides, polyetheretherketones, and polyetherimides, and mixtures and copolymers thereof.

In the context of the present invention, component c) is more preferably a polyamide composition. Advantageously, component c) comprises at least one polyamide chosen from PA 4,6, PA6, PA66 and mixtures thereof (of two polyamides as recited herein or a mixture of PA4,6, PA6 and PA66). The term mixture is to be understood as ‘combination of more than one polyamide’, such as a blend or copolymer. Component c) can thus also comprise a copolyamide of PA-6 and/or PA-6,6, and/or PA-4,6. Further, component c) can comprise (as a blend of, or copolymer of) other polyamides, such as amorphous and/or semi-crystalline polyamides. Suitable polyamides are all the polyamides known to a person skilled in the art, comprising semi-crystalline and amorphous polyamides that are melt-processable. Examples of suitable other polyamides according to the invention are aliphatic polyamides, for example PA-11, PA-12, PA-4,8, PA-4,10, PA-4,12, PA-6,9, PA-6,10, PA-6,12, PA-10,10, PA-12,12, PA-6/6,6-copolyamide, PA-6/12-copolyamide, PA-6/11-copolyamide, PA-6,6/11-copolyamide, PA-6,6/12-copolyamide, PA-6/6,10-copolyamide, PA-6,6/6,10-copolyamide, PA-4,6/6-copolyamide, PA-6/6,6/6,10-terpolyamide, and copolyamides obtained from 1,4-cyclohexanedicarboxylic acid and 2,2,4- and 2,4,4-trimethylhexamethylene-diamine, aromatic polyamides, for example PA-6,I, PA-6,l/6,6-copolyamide, PA-6,T, PA-6,T/6-copolyamide, PA-6,T/6,6-copolyamide, PA-6,l/6,T-copolyamide, PA-6,6/6,T/6,I-copolyamide, PA-6,T/2-MPMDT-copolyamide (2-MPMDT=2 methylpentamethylene diamine), PA-9,T, copolyamides obtained from terephthalic acid, 2,2,4- and 2,4,4-tri-methyl-hexa-methylenediamine, copolyamide obtained from isophthalic acid, laurinlactam and 3,5-dimethyl-4,4-diamino-dicyclohexylmethane, copolyamides obtained from isophthalic acid, azelaic acid and/or sebacic acid and 4,4-diaminodicyclo-hexyl-methane, copolyamides obtained from caprolactam, isophthalic acid and/or terephthalic acid and 4,4-diaminodicyclohexyl-methane, copolyamides obtained from caprolactam, isophthalic acid and/or terephthalic acid and isophoronediamine, copolyamides obtained from isophthalic acid and/or terephthalic acid and/or other aromatic or aliphatic dicarboxylic acids, optionally alkyl-substituted hexamethylenediamine and alkyl-substituted 4,4-diaminodicyclohexylamine, and also copolyamides and mixtures of the aforementioned polyamides.

More preferably, the thermoplastic polymer in component c) comprises a semi-crystalline polyamide. Semi-crystalline polyamides have the advantage of having good thermal properties and mould filling characteristics. Also still more preferably, the thermoplastic polymer comprises a semi-crystalline polyamide with a melting point of at least 200° C., more preferably at least 220° C., 240° C., or even 260° C. and most preferably at least 280° C. Semi-crystalline polyamides with a higher melting point have the advantage that the thermal properties are further improved. With the term melting point is herein understood the temperature measured by DSC with a heating rate of 5° C. falling in the melting range and showing the highest melting rate. Preferably a semi-crystalline polyamide is chosen from the group comprising PA-6,10, PA-11, PA-12, PA-12,12, PA-6,I, PA-6,T, PA-6,T/6,6-copolyamide, PA-6,T/6-copolyamide, PA-6/6,6-copolyamide, PA-6,6/6,T/6,I-copolyamide, PA-6,T/2-MPMDT-copolyamide, PA-9,T, PA-4,6/6-copolyamide and mixtures and copolyamides of the aforementioned polyamides. More preferably PA-6,I, PA-6,T, PA-6,6, PA-6,6/6T, PA-6,6/6,T/6,I-copolyamide, PA-6,T/2-MPMDT-copolyamide, PA-9,T or PA-4,6, or a mixture or copolyamide thereof, is chosen as the polyamide. Still more preferably, the semi-crystalline polyamide comprises PA-4,6, or a copolyamide thereof.

In the context of the present invention, the polyamide (composition comprising a polyamide as defined above) can be a homopolymer, or a copolymer comprising more than one polyamide, such as two polyamides, three polyamides, four polyamides, five polyamides, six polyamides, a copolymer comprising at least one polyamide and at least one other thermoplastic polymer. Said other thermoplastic polymer can be selected from the group: polyesters; polyarylene sulfides such as polyphenylene sulfides; polyarylene oxides such as polyphenylene oxides; polysulfones; polyarylates; polyimides; poly(ether ketone)s such as polyetheretherketones; polyetherimides; polycarbonates, copolymers of said polymers among each other and/or with other polymers, including thermoplastic elastomers such as copolyetherester block copolymers, copolyesterester block copolymers, and copolyetheramide block copolymers; and mixtures of said polymers and copolymers. The thermoplastic polymer suitably is an amorphous, a semi-crystalline or a liquid crystalline polymer, an elastomer, or a combination thereof. Liquid crystal polymers are preferred due to their highly crystalline nature and ability to provide a good matrix for the filler material. Examples of liquid crystalline polymers include thermoplastic aromatic polyesters.

The thermoconductive polymer composition according to the present invention may comprise from 0 to 5 wt. % of optional further component(s) (relative to the total weight of the composition according to the present invention). These further components are also designated herein as additives. Preferably, the total amount of optional further components, if any, is in the range from 0 to 3 wt. %. Herein, the weight percentages are based on the total weight of the thermoconductive polymer composition. If a flame-retardant is the optional further component(s), the amount in is the range from 10 to 20% by weight, more preferably 5-18 wt. %, most preferably 10-18 wt. % of additives as recited herein.

As additives, the polymer composition may comprise any auxiliary additives, known to a person skilled in the art that are customarily used in polymer compositions. Preferably, these other additives should not detract, or not in a significant extent, from the invention. Such additives include, in particular, additional thermally conductive fillers next to the above specified graphite powder; other fillers not considered thermally conductive such as non-conductive reinforcing fillers; pigments; dispersing aids; processing aids for example lubricants and mould release agents; impact modifiers; plasticizers; crystallization accelerating agents; nucleating agents; flame retardants; UV stabilizers; antioxidants; and heat stabilizers. A surprisingly enhanced effect of flame-retardancy has been observed when a flame retardant, in particular decabromo-diphenyl-ethane (DBPDE) is added to the composition according to the present invention. The flame retardant effect is enhanced when the flame retardant additive is part of the composition according to the present invention, compared to other compositions, not comprising talc and glass fibers as recited herein. Particularly good results have been obtained when the amount of flame retardant in present in the range from 10 to 20 wt. %, preferably from 12 to 18 wt. %.

According to one embodiment of the present invention, the thermoconductive polymer consists of components a), b) and c) as recited in the context of the present invention and a further component d) which is 0-10 wt. %, preferably 0-5 wt. %, more preferably 0-2.5 wt. % of additives as recited herein. Typically, d) can be 0.01-10 wt. %, 0.05-5 wt. %, 0.05-2 wt. %.

According to one embodiment of the present invention, good results can be obtained when the amount of polyamide composition in the thermoconductive polymer composition is in the range from 30 wt. % to 50 wt. %, preferably in the range from 30 wt % to 50 wt. %, more preferably in the range from 30 wt. % to 45 wt. %, most preferably in the range from 30 to 40 wt. %. The polyamide composition in the thermoconductive polymer composition is advantageously at most 40 wt. %, more advantageously most 35 wt. %. of the total weight of the composition.

According to one embodiment of the present invention, the thermoconductive thermoplastic composition comprises, or consists of:

10-20 wt. % of glass fibers,

40-45 wt. % of talc,

30-40 wt. %, preferably 35-40 wt. % of a thermoplastic polymer, and

0-5 wt. %, preferably 0-3 wt. % of further components, or 10-20 wt. % of at least one flame retardant,

relative to the total weight of the thermoconductive thermoplastic composition. The composition comprising 10-20 wt. % of glass fibers, 40-45 wt. % of talc, 30-40 wt. %, preferably 35-40 wt. % of a thermoplastic polymer, and 0-5 wt. %, preferably 0-3 wt. % of further components, as recited here above achieves excellent results to the required mechanical and thermal conductivity properties. It the composition also comprises 10-20 wt. % of at least one flame retardant, the flame retardant properties are enhanced by the presence of the glass fibers and the talc. The thermoconductive polymer composition according to the present invention has a through-plane thermal conductivity of 0.5 to 1 W/m·K, preferably 0.6 to 0.8 W/m·K. Typically, thermoconductive polymer composition has a parallel thermal conductivity of 0.8 to 3 W/m·K, preferably 1.2 to 2.5 W/m·K. Herein the thermal conductivity is derived from the thermal diffusivity (D) measured by laser flash technology according to ASTM E1461-01 on injection moulded samples of 80×80×2 mm in through plane respectively in-plane direction, the bulk density (ρ) and the specific heat (Cp), at 20° C., using the method described in Polymer Testing (2005, 628-634).

The thermal conductivity (or thermoconductivity) of a plastic composition is herein understood to be a material property, which can be orientation dependent and which also depends on the history of the composition. For determining the thermal conductivity of a plastic composition, that material has to be shaped into a shape suitable for performing thermal conductivity measurements. Depending on the composition of the plastic composition, the type of shape used for the measurements, the shaping process as well as the conditions applied in the shaping process, the plastic composition may show an isotropic thermal conductivity or an anisotropic, i.e. orientation dependent thermal conductivity. In case the plastic composition is shaped into a flat rectangular shape, the orientation dependent thermal conductivity can generally be described with three parameters: Λ_{⊥}, Λ_{//} and Λ_{±}, wherein Λ_ is the through-plane thermal conductivity, Λ_{//} is the in-plane thermal conductivity in the direction of maximum in-plane thermal conductivity, also indicated herein as parallel or longitudinal thermal conductivity and Λ_{±} is the in-plane thermal conductivity in the direction of minimum in-plane thermal conductivity. It is noted that the through-plane thermal conductivity is indicated elsewhere also as “transversal” thermal conductivity.

In case of a polymer composition with a dominant parallel orientation of plate-like particles in plane with the planar orientation of the plate, the polymer composition may show an isotropic in-plane thermal conductivity, i.e. Λ_{//} is approximately equal to Λ_{±}.

For measurement of Λ_{⊥} and Λ_{//} samples with dimensions of 80×80×2 mm were prepared from the material to be tested by injection moulding using an injection moulding machine equipped with a square mould with the proper dimensions and a film gate of 80 mm wide and 2 mm high positioned at one side of the square. Of the 2 mm thick injection moulded plaques the thermal diffusivity D, the density (ρ) and the heat capacity (Cp) were determined. The thermal diffusivity was determined in a direction in-plane and parallel (D_{//}) to the direction of polymer flow upon mould filling, as well as through plane (D_{⊥}), according to ASTM E1461-01 with Netzsch LFA 447 laserflash equipment. The in-plane thermal diffusivity D_{//} was determined by first cutting small strips or bars with an identical width of about 2 mm wide from the plaques. The length of the bars was in the direction perpendicular to the polymer flow upon mould filling. Several of these bars were stacked with the cut surfaces facing outwards and clamped very tightly together. The thermal diffusivity was measured through the stack from one side of the stack formed by an array of cut surfaces to the other side of the stack with cut surfaces.

The heat capacity (Cp) of the plates was determined by comparison to a reference sample with a known heat capacity (Pyroceram 9606), using the same Netzsch LFA 447 laserflash equipment and employing the procedure described by W. Nunes dos Santos, P. Mummery and A. Wallwork, Polymer Testing 14 (2005), 628-634. From the thermal diffusivity (D), the density (ρ) and the heat capacity (Cp), the thermal conductivity of the moulded plaques was determined in a direction parallel (Λ_{//}) to the direction of polymer flow upon mold filling, as well as perpendicular to the plane of the plaques (Λ_{⊥}), according to formula:

Λₓ=Dₓ*ρ*Cp

wherein x=// and ⊥, respectively.

The polymer composition according to the invention is not only thermoconductive, but has also good mechanical properties, which can vary over a wide range depending on the amount of the glass fibers and talc and optionally additional thermally conductive fillers therein. At higher total amounts of thermally conductive filler much higher thermal conductivities are obtained compared to other thermally conductive fillers when used in similar amounts.

As recited above, the thermoconductive polymer composition according to the present invention generally has good flow properties ensuring a good heat-processability. Preferably, the thermoconductive polymer composition has a spiral flow length of at least 100 mm, more preferably at least 130 mm and most preferably at least 160 mm at 1000 bar injection pressure. The spiral flow length is determined by injecting the molten thermoplastic material into a long spiral-channel cavity having dimensions 280×15×2 mm and the length of the resulting flow for that material is its spiral flow length. The material is injected by using a 22 mm Engel 45B L/d=19 injection moulding machine having a theoretical shot volume of 38 cm³; the cylinder temperature is 10° C. above the melting point of the main polymer component, and the effective injection pressure is 1000 bar.

The thermoconductive polymer composition according to the present invention is further characterized by a good mechanical performance. Typically, the thermally conductive polymer has a tensile strength of at least 80 MPa, preferably at least 90 MPa and more preferably at least 100 MPa. Typically, the thermoconductive polymer composition has an elongation at break of at least 0.7%, preferably at least 1.0%, more preferably at least 1.5%, and most preferably at least 2.0%. Typically, the thermoconductive polymer composition has a stiffness of at least 7000 MPa, more preferably at least 9000 MPa. Tensile modulus, tensile strength and elongation at break are determined at 23° C. and 5 mm/min according to ISO 527; the dried granulate of the thermoplastic material to be tested was injection moulded to form the test bars for the tensile tests having a thickness of 4 mm conforming to ISO 527 type 1A.

The thermoconductive polymer composition according to the present invention may be prepared by mixing the thermoplastic polymer, the glass fibers, the talc and optionally further component(s) in an extruder as it is well known to the person skilled in the art.

Preferably, the process comprising steps, following the melt mixing, of
extruding the melt through one or more orifices to form an extruded strand or strands;
cutting the extruded strand or strands, to form pellets,
and cooling the pellets, thereby forming solid pellets.

The advantage of cutting the strands prior to cooling, is that this allows the thermally conductive polymer composition to be obtained in pellets. In case of cooling prior to cutting, in particular with somewhat higher contents of glass fibers, cutting of the material might have become very hard, and a powdered material rather than pellets are obtained. Pellets are preferred in most cases for further processing, such as in injection moulding.

Advantageously, the extruded polymer composition is converted to pellets by standard strend granulation. In this case the polymer composition is extruded through the orifices in a die-plate and is cut immediately after leaving the die by cutting blades, cooled and optionally grinded to reduce the particle size. The so or otherwise prepared pellets may be further processed into the desired shape by any known method suitable for processing thermoplastic materials. Preferably, the thermally conductive polymer composition according to the present invention is processed by injection moulding.

Moulded articles comprising the composition according to the present invention may be prepared by any known processes. The thermoconductive polymer composition may for example be used to make various articles for electrical or electronic applications. The thermoconductive polymer composition can for example be used in components of an electrical or electronic assembly or in engine parts. In particular, the present thermally conductive polymer composition may be used in heat sinks.

The invention is further illustrated by the following examples and comparative experiments.

### EXAMPLES

The thermoconductive polymer compositions according to the present invention were prepared from polyamide-46 (PA46) and varying amounts of glass fibers (GF) and talc. The different samples prepared are described in table 1. Similar results are obtained with polyamide-6.

### Example A (EX-A)

35 wt. % PA46, 20 wt. %GF,45 wt. % talc; density: 1.8 g/cm³

### Example B (EX-B)

33 wt. % PA46, 15 wt. % GF,52 wt. % talc; density: 1.9 g/cm³

### Comparative Example A (CE-A)

55 wt. % PA46, 45 wt. % talc (no glass fiber): 1.5 g/cm³

### Comparative Example B (CE-B)

40 wt. % PA46, 60 wt. % glass fibers alone (no talc)

### Comparative Example C (CE-C)

70 wt. % PA46, 30 wt. talc (no glass fiber)

### Comparative Example D (CE-D)

PA46 alone (no talc, no glass fiber)

TABLE 1

| Thermoconductivity (W/mK) | EX-A | EX-B | CE-A | CE-B | CE-C | CE-D |
|---|---|---|---|---|---|---|
| Through plane | 0.67 | 0.67 | 0.47 | 0.47 | 0.42 | 0.20 |
| In plane // | 1.98 | 2.24 | 1.53 | 0.53 | 1.03 | 0.20 |

From table 1, the synergic effect of the presence of the talc with glass fibers can be observed: the comparison of EX-A with CE-A (same amount of talc, but no glass fibers) show that the thermoconductivity of the polymer composition comprising talc is enhanced when both talc and glass fibers are present.

Compared to the unfilled polymer (CE-D), the composition according to the present invention provides a higher thermoconductivity (EX-A and EX-B) and the mechanical properties of this compositions EX-A and EX-B, such as brittleness, mouldability, flow properties, are satisfactory for various applications.

1. Thermoconductive polymer composition comprising:
a) 10-30 wt. % of glass fibers;
b) 40-55 wt. % of talc;
c) 20-50 wt. % of a thermoplastic polymer comprising at least one polyamide selected from the group consisting of PA46, PA6, PA66 and mixtures thereof;
wherein the sum of a) and b) is at least 50 wt. % and at most 70 wt. % and wherein the weight percentages (wt. %) are relative to the total weight of the composition.

2. Composition according to claim 1, wherein the weight ratio glass fibers:talc is in the range from 1:1 to 1:6.

3. Composition according to claim 1, wherein the amount of glass fibers is in the range from 15 wt. % to 30 wt. % of the total weight of the composition.

4. Composition according to claim 1, wherein the sum of a) and b) is in the range from 60 wt. % to 70 wt. % of the total weight of the composition.

5. Composition according to claim 1, wherein the thermoplastic polymer composition in component c) further comprises a thermoplastic polymer chosen from the group consisting of other polyamides, polyesters, polyphenylene sulphides, polyphenylene oxides, polysulfones, polyarylates, polyimides, polyetheretherketones, and polyetherimides, and mixtures thereof.

6. Composition according to claim 1, comprising:
a. 10-20 wt. % of glass fibers,
b. 40-45 wt. % of talc,
c. 30-40 wt. %, preferably 35-40 wt. % of a thermoplastic polymer, and
d. 10-20 wt. % of at least one flame retardant,
relative to the total weight of the thermoconductive thermoplastic composition.

7. Composition according to claim 6, wherein the flame retardant is decabromo-diphenyl ethane.

8. Moulded article comprising the composition according to claim 1.

9. Method for the manufacture of a thermoconductive polymer composition according to claim 1, comprising mixing a thermoplastic polymer, glass fibers, talc and optionally further component(s) in an extruder.

10. Method for the manufacture of a moulded article according to claim 8, comprising injection molding of a composition.
